(19) United States
(12) Patent Application Publication
(10) Pub. No.: US 2023/0186102 A1
(43) Pub. Date: Jun. 15, 2023

(54) TRAINING METHOD AND APPARATUS FOR NEURAL NETWORK MODEL, DEVICE AND STORAGE MEDIUM

(71) Applicant: Beijing Baidu Netcom Science Technology Co., Ltd., Beijing (CN)

(72) Inventor: Bo JING, Beijing (CN)

(21) Appl. No.: 18/077,471

(22) Filed: Dec. 8, 2022

(30) Foreign Application Priority Data
Dec. 10, 2021 (CN) 202111506310.7

(51) Int. Cl. G06N 3/098

(52) U.S. Cl. CPC G06N 3/098

(57) ABSTRACT

Provided are a training method and apparatus for a neural network model, a device and a storage medium. the training method includes: acquiring a feature representation ciphertext of a sample user from each feature provider of at least two feature providers separately; and determining the loss error ciphertext and the gradient ciphertext of a tag neuron in a tag sub-neural network based on the tag sub-neural network according to the feature representation ciphertext and a tag ciphertext; controlling the each feature provider to decrypt the gradient ciphertext of the tag neuron to obtain a decryption result and updating the network parameter of the tag neuron according to the decryption result acquired from the each feature provider; and sending the loss error ciphertext of an association neuron to the each feature provider.

### CROSS-REFERENCE TO RELATED APPLICATION(S)

This application claims priority to Chinese Patent Application No. 202111506310.7 filed Dec. 10, 2021, the disclosure of which is incorporated herein by reference in its entirety.

### TECHNICAL FIELD

The present disclosure relates to the field of computer technology, in particular, to the field of blockchain technology and artificial intelligence technology and, specifically, to a training method and apparatus for a neural network model, a device and a storage medium.

### BACKGROUND

With the development of artificial intelligence technology, machine learning is more and more widely used in various scenarios.

Federated machine learning is an important research direction of artificial intelligence. However, in federated learning, how to use data and model machine learning on the premise that the privacy of participants is protected is very important.

### SUMMARY

The present disclosure provides a training method and apparatus for a neural network model, a device and a storage medium.

According to an aspect of the present disclosure, a training method for a neural network model is provided. The method includes the steps below.

A feature representation ciphertext of a sample user is acquired from each feature provider of at least two feature providers separately. The feature representation ciphertext is determined based on a feature sub-neural network in each feature provider according to the feature data of the sample user on a feature term associated with each of the at least two feature providers.

The tag ciphertext of the sample user is determined. The loss error ciphertext and the gradient ciphertext of a tag neuron in a tag sub-neural network are determined based on the tag sub-neural network according to the feature representation ciphertext and the tag ciphertext.

Each feature provider is controlled to decrypt the gradient ciphertext of the tag neuron to obtain a decryption result. The network parameter of the tag neuron is updated according to the decryption result acquired from each feature provider.

A tag neuron connected to a feature neuron in the feature sub-neural network is used as an association neuron of the feature sub-neural network. The loss error ciphertext of the association neuron is sent to the each feature provider. The loss error ciphertext is decrypted by the each feature provider to obtain a loss error plaintext. The network parameter of the feature neuron is updated according to the loss error plaintext.

The to-be-trained neural network model includes at least two feature sub-neural networks and a tag subnetwork.

According to another aspect of the present disclosure, a training method for a neural network model is provided. The method includes the steps below.

The feature representation ciphertext is determined based on the feature sub-neural network in the feature provider according to the feature data of the sample user on the feature term associated with the feature provider.

The feature representation ciphertext is sent to a tag provider. The tag provider determines the loss error ciphertext and the gradient ciphertext of the tag neuron in the tag sub-neural network based on the tag sub-neural network according to the feature representation ciphertext acquired from each of the at least two feature providers and the tag ciphertext.

The gradient ciphertext of the tag neuron is decrypted to obtain the decryption result. The tag provider is controlled to update the network parameter of the tag neuron according to the decryption result.

The loss error ciphertext of the association neuron is acquired from the tag neuron. The acquired loss error ciphertext is decrypted to obtain the loss error plaintext. The network parameter of the feature neuron in the feature sub-neural network is updated according to the loss error plaintext. The association neuron is the tag neuron connected to the feature neuron.

The to-be-trained neural network model includes at least two feature sub-neural networks and a tag subnetwork.

According to another aspect of the present disclosure, a training apparatus for a neural network model is provided. The apparatus includes a feature representation ciphertext module, a homomorphic ciphertext computation module, a tag neuron update module and a feature neuron update module.

The feature representation ciphertext module is configured to acquire the feature representation ciphertext of the sample user from each feature provider of at least two feature providers separately. The feature representation ciphertext is determined based on the feature sub-neural network in the each feature provider according to the feature data of the sample user on the feature term associated with the each feature provider.

The homomorphic ciphertext computation module is configured to determine the tag ciphertext of the sample user and determine the loss error ciphertext and the gradient ciphertext of the tag neuron in the tag sub-neural network based on the tag sub-neural network according to the feature representation ciphertext and the tag ciphertext.

The tag neuron update module is configured to determine the tag ciphertext of the sample user and determine the loss error ciphertext and the gradient ciphertext of the tag neuron in the tag sub-neural network based on the tag sub-neural network according to the feature representation ciphertext and the tag ciphertext.

The feature neuron update module is configured to use the tag neuron connected to the feature neuron in the feature sub-neural network as the association neuron of the feature sub-neural network, send the loss error ciphertext of the association neuron to each feature provider, decrypt, by each feature provider the loss error ciphertext to obtain the loss error plaintext and update the network parameter of the feature neuron according to the loss error plaintext.

The to-be-trained neural network model includes at least two feature sub-neural networks and a tag subnetwork.

According to another aspect of the present disclosure, a training apparatus for a neural network model is provided. The apparatus includes a feature representation ciphertext determination module, a feature representation ciphertext sending module, a gradient ciphertext decryption module and a feature neuron update module.

The feature representation ciphertext determination module is configured to determine the feature representation ciphertext based on the feature sub-neural network in the feature provider according to the feature data of the sample user on the feature term associated with the feature provider.

The feature representation ciphertext sending module is configured to send the feature representation ciphertext to the tag provider and configured the tag provider to determine the loss error ciphertext and the gradient ciphertext of the tag neuron in the tag sub-neural network based on the tag sub-neural network according to the feature representation ciphertext acquired from each of the at least two feature providers and the tag ciphertext.

The gradient ciphertext decryption module is configured to decrypt the gradient ciphertext of the tag neuron to obtain the decryption result and control the tag provider to update the network parameter of the tag neuron according to the decryption result.

The feature neuron update module is configured to acquire the loss error ciphertext of the association neuron from the tag neuron, decrypt the acquired loss error ciphertext to obtain the loss error plaintext and update the network parameter of the feature neuron in the feature sub-neural network according to the loss error plaintext. The association neuron is the tag neuron connected to the feature neuron.

The to-be-trained neural network model includes at least two feature sub-neural networks and a tag subnetwork.

According to another aspect of the present disclosure, an electronic device is provided. The electronic device includes at least one processor and a memory communicatively connected to the at least one processor.

The memory stores instructions executable by the at least one processor to enable the at least one processor to execute the training method for a neural network model according to any embodiment of the present disclosure.

According to another aspect of the present disclosure, a non-transitory computer-readable storage medium is provided. The storage medium stores computer instructions for causing a computer to execute the training method for a neural network model according to any embodiment of the present disclosure.

According to another aspect of the present disclosure, a computer program product is provided. The computer program product includes a computer program. When executing the computer program, a processor performs the training method for a neural network model according to any embodiment of the present disclosure.

It is to be understood that the content described in this part is neither intended to identify key or important features of the embodiments of the present disclosure nor intended to limit the scope of the present disclosure. Other features of the present disclosure are apparent from the description provided hereinafter.

### BRIEF DESCRIPTION OF DRAWINGS

The drawings are intended to provide a better understanding of the solution and not to limit the present disclosure.

FIG. 1A is a diagram of a training method for a neural network model according to an embodiment of the present disclosure.

FIG. 1B is a diagram illustrating the structure of a to-be-trained neural network model according to an embodiment of the present disclosure.

FIG. 2 is a diagram of another training method for a neural network model according to an embodiment of the present disclosure.

FIG. 3 is a diagram of another training method for a neural network model according to an embodiment of the present disclosure.

FIG. 4 is a diagram of another training method for a neural network model according to an embodiment of the present disclosure.

FIG. 5 is a diagram of another training method for a neural network model according to an embodiment of the present disclosure.

FIG. 6 is a diagram of another training method for a neural network model according to an embodiment of the present disclosure.

FIG. 7 is a diagram of a training apparatus for a neural network model according to an embodiment of the present disclosure.

FIG. 8 is a diagram of another training apparatus for a neural network model according to an embodiment of the present disclosure.

FIG. 9 is a block diagram of an electronic device for implementing a training method for a neural network model according to an embodiment of the present disclosure.

### DETAILED DESCRIPTION

Exemplary embodiments of the present disclosure, including details of embodiments of the present disclosure, are described hereinafter in conjunction with the drawings to facilitate understanding. The exemplary embodiments are merely illustrative. Therefore, it is appreciated by those of ordinary skill in the art that various changes and modifications may be made to the embodiments described herein without departing from the scope and spirit of the present disclosure. Similarly, description of well-known functions and constructions is omitted hereinafter for clarity and conciseness.

In an embodiment of the present disclosure, a feature provider is configured to provide the feature data of a sample user. Each feature provider has a feature term associated with the feature provider, and the feature term refers to a feature dimension. A tag provider is configured to provide the tag data of the sample user. A to-be-trained neural network model may include at least two feature sub-neural networks and a tag sub-neural network. A feature sub-neural network may be configured in the electronic device of each feature provider. The feature sub-neural network of each feature provider is different. The tag sub-neural network may be configured in the electronic device of the tag provider. The neuron in the feature sub-neural network is a feature neuron. The neuron in the tag sub-neural network is a tag neuron. In the following specific example, participant A may have feature sub-neural network A, participant B may have feature sub-neural network B, parameter C may have tag sub-neural network C, participant A may be associated with feature terms 1 to 12, and participant B may be associated with feature terms 13 to 20.

The solution provided by the embodiments of the present disclosure is described in detail below in conjunction with the drawings.

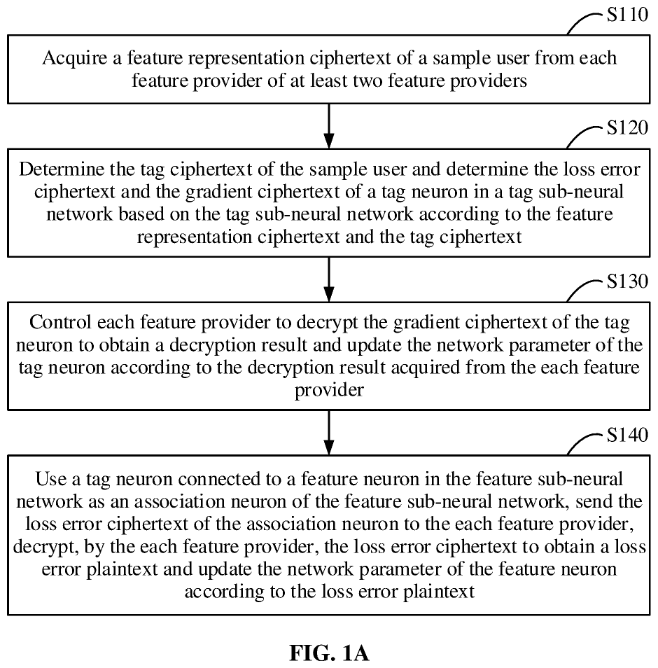

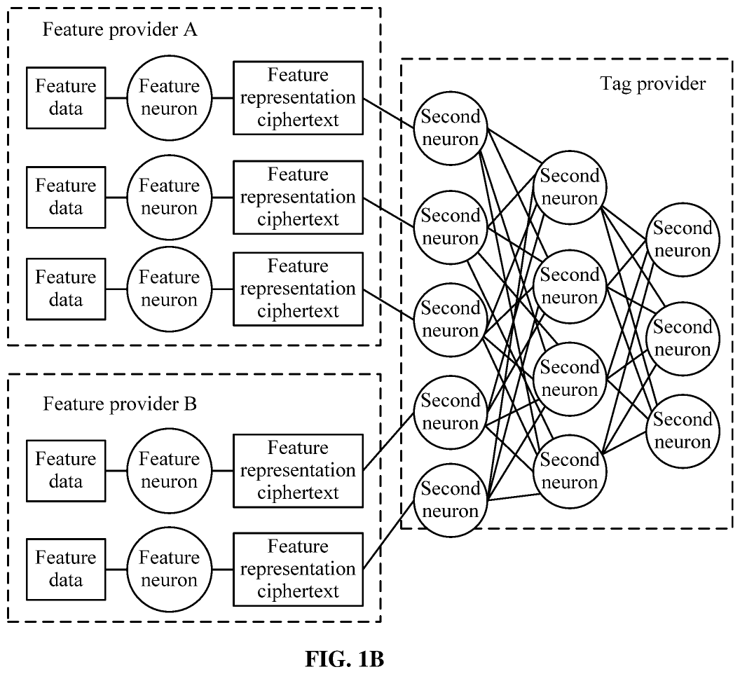

FIG. 1A is a diagram of a training method for a neural network model according to an embodiment of the present disclosure. This embodiment of the present disclosure may be applicable to the case where multiple parties participate in joint learning. This method may be executed by a training apparatus for a neural network model. This apparatus may be performed by hardware and/or software and may be disposed in the electronic device of the tag provider. That is, the training method for a neural network model provided by this embodiment may be executed by the tag provider. Referring to FIG. 1A, this method includes the steps below.

In S110, a feature representation ciphertext of a sample user is acquired from each feature provider of at least two feature providers separately. The feature representation ciphertext is determined based on a feature sub-neural network in the each feature provider according to the feature data of the sample user on a feature term associated with each of the at least two feature providers.

In S120, the tag ciphertext of the sample user is determined. The loss error ciphertext and the gradient ciphertext of a tag neuron in a tag sub-neural network are determined based on the tag sub-neural network according to the feature representation ciphertext and the tag ciphertext.

In S130, the each feature provider is controlled to decrypt the gradient ciphertext of the tag neuron to obtain a decryption result. The network parameter of the tag neuron is updated according to the decryption result acquired from the each feature provider.

In S140, a tag neuron connected to a feature neuron in the feature sub-neural network is used as an association neuron of the feature sub-neural network. The loss error ciphertext of the association neuron is sent to the each feature provider. The loss error ciphertext is decrypted by the each feature provider to obtain a loss error plaintext. The network parameter of the feature neuron is updated according to the loss error plaintext.

The to-be-trained neural network model includes at least two feature sub-neural networks and a tag subnetwork.

In this embodiment of the present disclosure, the feature provider is configured to provide the feature data of the sample user on a feature term, but not to provide the tag data of the sample user. The feature term associated with each feature provider is different, that is, the feature term provided by each feature provider is different. The number of feature terms provided by each feature provider can be the same or different. The feature provider is configured to provide the tag data of the sample user, but not to provide the feature data of the sample user.

FIG. 1B is a diagram illustrating the structure of a to-be-trained neural network model according to an embodiment of the present disclosure. Referring to FIG. 1B, for example, feature provider A, feature provider B and a tag provider participate in joint learning. The to-be-trained neural network model may include two feature sub-neural networks and a tag sub-neural network. Each feature sub-neural network is configured in a respective feature provider, that is, each feature provider has a respective feature sub-neural network. Each feature sub-neural network is different. The tag sub-neural network is configured in the tag provider, that is, the tag provider has the tag sub-neural network. It is to be noted that more than two feature providers may participate in the joint learning.

In this embodiment of the present disclosure, for each feature provider, the feature data of the sample user on a respective feature term may be input to the feature sub-neural network of the feature provider to obtain the output result of the feature sub-neural network. A feature representation ciphertext is determined according to the output result, and the feature representation ciphertext of the sample user is sent to the tag provider.

The tag provider may input the feature representation ciphertext acquired from each feature provider into the tag sub-neural network. The tag sub-neural network performs forward propagation through ciphertext computation to obtain the activation value ciphertext of an output layer in the tag sub-neural network. The loss function of the output layer is determined according to the tag ciphertext of the sample user and the activation value ciphertext of the output layer. The partial derivative of the loss function to the tag neuron is computed to obtain the loss error ciphertext of the tag neuron. The gradient ciphertext of the tag neuron is obtained according to the loss error ciphertext of the tag neuron and the connection weight of the tag neuron. The tag neuron is a neuron in the tag sub-neural network.

The tag provider may also send the gradient ciphertext of the tag neuron to any feature provider. The feature provider decrypts the gradient ciphertext of the tag neuron to obtain a decryption result. The feature provider may also update the network parameter of the tag neuron according to the decryption result acquired from the feature provider.

For each feature provider, the tag provider may also use a tag neuron connected to the feature provider as an association neuron of the feature provider and send the loss error ciphertext of the association neuron to the feature provider. The feature provider decrypts the loss error ciphertext of the association neuron to obtain the loss error plaintext of the association neuron and uses the loss error plaintext of the association neuron to update the network parameter of the feature neuron in the feature provider. The feature neuron is a neuron in the feature sub-neural network. The feature neuron in the last layer of the feature sub-neural network is connected to the association neuron in the tag sub-neural network.

During model training, the tag provider performs ciphertext computation according to the tag ciphertext of the sample user and the feature representation ciphertext of the sample user acquired from each of the at least two feature providers, so that the feature data of the sample user can be prevented from being leaked to the tag provider. Moreover, each feature provider of at least two feature providers is controlled to decrypt the gradient ciphertext of the tag neuron, so that the tag data of the sample user can be prevented from being leaked to the feature provider. On the premise that participants do not expose their data privacy, there is no need to introduce a trusted third party, the joint learning is implemented, and the efficiency of the model training is improved. Moreover, each feature provider merely needs to update the network parameter of the respective feature sub-neural network and does not need to update the network parameter of the tag sub-neural network. The network structure and the network parameter of each feature sub-neural network may be different. The tag provider merely needs to update the network parameter of the tag sub-neural network and does not need to update the network parameter of the feature sub-neural network. In this manner, the training computation complexity can also be reduced, and a high applicability is achieved.

In the technical solution provided by this embodiment of the present disclosure, on the premise that each participant does not expose the respective data privacy, there is no need to introduce the trusted third party, the joint learning is implemented, and the efficiency of the model training is improved. Moreover, each feature provider merely needs to update the network parameter of the respective feature sub-neural network, and the tag provider merely needs to update the network parameter of the tag sub-neural network. In this manner, the training computation complexity can also be reduced, and a high applicability is achieved.

In an optional embodiment, a feature representation ciphertext is obtained by performing homomorphic encryption on the feature representation plaintext of the sample user. The feature representation plaintext is the output result of the feature sub-neural network with regard to the feature data. The tag ciphertext is obtained by performing homomorphic encryption on the tag data of the sample user.

The feature data and the tag data of the sample user are data plaintexts rather than data ciphertexts.

Specifically, the feature provider may input its feature data into its feature sub-neural network to obtain the feature representation plaintext output by the feature sub-neural network and use a homomorphic encryption public key to perform homomorphic encryption on the feature representation plaintext to obtain the feature representation ciphertext. The feature provider also sends the feature representation ciphertext of the sample user to the tag provider. The tag provider may use a homomorphic encryption public key to perform homomorphic encryption on the tag data to obtain the tag ciphertext. It is to be noted that the feature provider may have a homomorphic encryption public key and a homomorphic encryption private key. The homomorphic encryption public key and the homomorphic encryption private key form an asymmetric key pair. The asymmetric key pair of each feature provider is the same. The tag provider may have only a homomorphic encryption public key, but not have a homomorphic encryption private key. The tag provider performs homomorphic ciphertext computation according to the feature representation ciphertext and the tag ciphertext and controls the feature provider to homomorphically decrypt the gradient ciphertext of the tag neuron. In this manner, joint learning between the two parties is implemented based on homomorphism encryption, and there is no need to introduce other trusted parties.

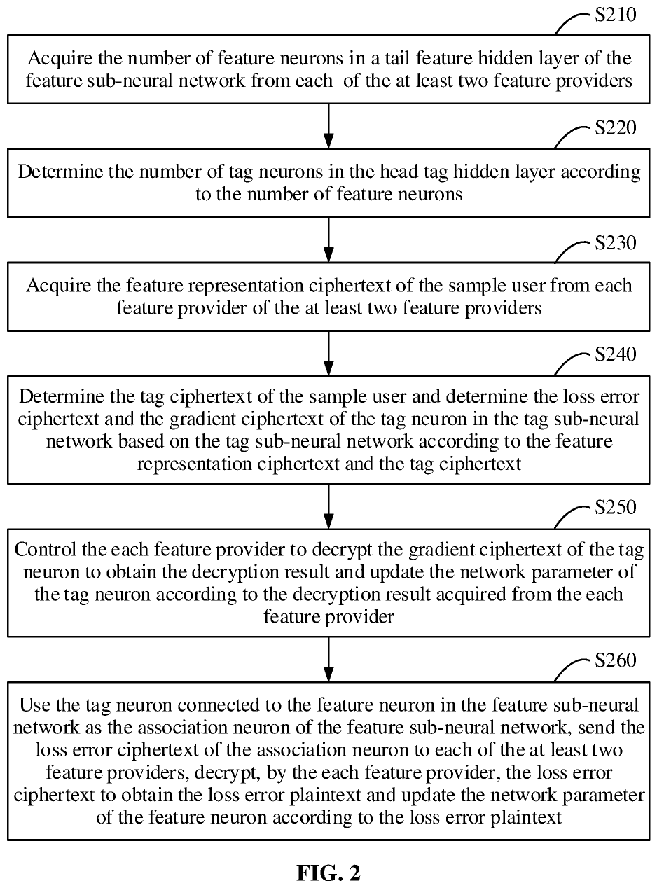

FIG. 2 is a diagram of another training method for a neural network model according to an embodiment of the present disclosure. This embodiment is an optional solution provided based on the preceding embodiment. In this embodiment of the present disclosure, the feature sub-neural network includes a feature input layer and at least one feature hidden layer. The tag sub-neural network includes at least one tag hidden layer and an output layer. Referring to FIG. 2, the training method for a neural network model according to this embodiment includes the steps below.

In S210, the number of feature neurons in a tail feature hidden layer of the feature sub-neural network is acquired from each of the at least two feature providers separately.

In S220, the number of tag neurons in the head tag hidden layer is determined according to the number of feature neurons.

In S230, the feature representation ciphertext of the sample user is acquired from each feature provider of the at least two feature providers separately. The feature representation ciphertext is determined based on the feature sub-neural network in each feature provider according to the feature data of the sample user on the feature term associated with the each feature provider.

In S240, the tag ciphertext of the sample user is determined. The loss error ciphertext and the gradient ciphertext of the tag neuron in the tag sub-neural network are determined based on the tag sub-neural network according to the feature representation ciphertext and the tag ciphertext.

In S250, each feature provider is controlled to decrypt the gradient ciphertext of the tag neuron to obtain the decryption result. The network parameter of the tag neuron is updated according to the decryption result acquired from the each feature provider.

In S260, the tag neuron connected to the feature neuron in the feature sub-neural network is used as the association neuron of the feature sub-neural network. The loss error ciphertext of the association neuron is sent to the each feature provider. The loss error ciphertext is decrypted by the each feature provider to obtain the loss error plaintext. The network parameter of the feature neuron is updated according to the loss error plaintext.

The to-be-trained neural network model includes at least two feature sub-neural networks and a tag subnetwork.

In this embodiment of the present disclosure, the feature sub-neural network may include not only a feature input layer, but also at least one feature hidden layer. The tag sub-neural network may include at least one tag hidden layer and an output layer, but not include a tag input layer. That is, the tag provider provides only the tag data, but does not provide feature data. That is, the to-be-trained neural network model is a distributed neural network model composed of each feature sub-neural network and tag sub-neural network. Since the feature sub-neural network also includes a feature hidden layer, and the feature data of the sample user passes through not only the feature input layer but also the feature hidden layer, the security of the feature data can be further improved.

Each feature provider may initialize the respective feature sub-neural network separately and send the number of feature neurons in the respective tail feature hidden layer to the tag provider. The tag provider sums the number of tail feature neurons in each feature provider and uses the summation result as the number of tag neurons in the head tag hidden layer in the tag sub-neural network. The tag provider may determine the network structure of the tag sub-neural network according to the number of tag neurons in the head tag hidden layer. The number of tag neurons in the head tag hidden layer is determined according to the number of feature neurons in each tail feature hidden layer, and the adaptability between the tag sub-neural network and each feature sub-neural network can be maintained according to the number of tag neurons in the first hidden layer.

In an optional embodiment, using the tag neuron connected to the feature neuron in the feature sub-neural network as the association neuron of the feature sub-neural network includes: selecting, from the tag neurons in the head tag hidden layer, a tag neuron connected to a feature neuron in the tail feature hidden layer of the feature sub-neural network and using the selected tag neuron as the association neuron of the feature sub-neural network.

Specifically, for each feature sub-neural network, the tag neuron connected to the feature neuron in the tail feature hidden layer of the feature sub-neural network is selected from the tag neurons of the head tag hidden layer and used as the association neuron of the feature sub-neural network. The number of feature neurons in the tail feature hidden layer of each feature sub-neural network may be different. Thus the number of association neurons of each feature sub-neural network may be different. Association neurons of different feature sub-neural networks do not overlap. If any tag neuron is an association neuron of any feature sub-neural network, the tag neuron is not an association neuron of another feature sub-neural network. The association neuron of each feature sub-neural network is accurately determined to lay a foundation for network update of each feature sub-neural network.

In the technical solution provided by this embodiment of the present disclosure, not only the data security of each participant can be protected, but also the reliability of the to-be-trained neural network model can be ensured.

In an optional embodiment, the method further includes the following. A candidate user identifier associated with each of the at least two feature providers is acquired from each of the at least two feature providers separately; the intersection of candidate user identifiers associated with the at least two feature providers is calculated to obtain a common user identifier; and the common user identifier is sent to the at least two feature providers to determine the sample user based on the common user identifier.

In this embodiment, a candidate user identifier associated with a feature provider is the candidate user identifier that the feature provider may provide. That is, the feature provider has the feature data of the user to whom the candidate user identifier belongs on the feature term associated with the feature provider.

Specifically, for each feature provider, the feature provider may send the respective associated candidate user identifier to the tag provider. The tag provider calculates the intersection of the candidate user identifiers associated with feature providers to obtain the common user identifier of each feature provider. The tag provider also feeds back the common user identifier to each feature provider. Each feature provider provides the feature representation ciphertext of the sample user according to the common user identifier. That is, the user to which the common user identifier belongs is used as the sample user. The user to which the common user identifier belongs is used as the sample user, then the integrity of the feature data of the sample user is ensured, and the stability of the joint learning is protected.

In an optional embodiment, the method further includes the following. A feature usage transaction request is initiated, and the feature usage transaction request includes a target feature term that the tag provider needs to use; a smart contract is invoked, the target feature term is matched with the candidate feature terms to be provided by at least two candidate feature providers, and a target feature provider is selected from the at least two candidate feature providers according to the matching result. The target feature provider and the tag provider are used as participants to perform joint learning of the to-be-trained neural network model.

Specifically, the tag provider may determine a to-be-used target feature term and initiate a feature usage transaction request including the target feature term. A candidate feature provider may publish a candidate feature term that the candidate feature provider can provide. The target feature term is matched with candidate feature terms. The target feature provider that is successfully matched is used as a feature provider. It is to be noted that the feature usage transaction request may also include information such as a usage price and a usage scenario and may also match information such as a price and a usage scenario. The tag provider may acquire the matching success notification of the target feature provider from a blockchain network and the tag provider and the target feature provider are used as participants to perform joint learning. Moreover, after the joint learning, recording may also be performed in the blockchain network. The feature provider and the tag provider are matched by the smart contract in a blockchain to improve the flexibility and reliability of the joint learning.

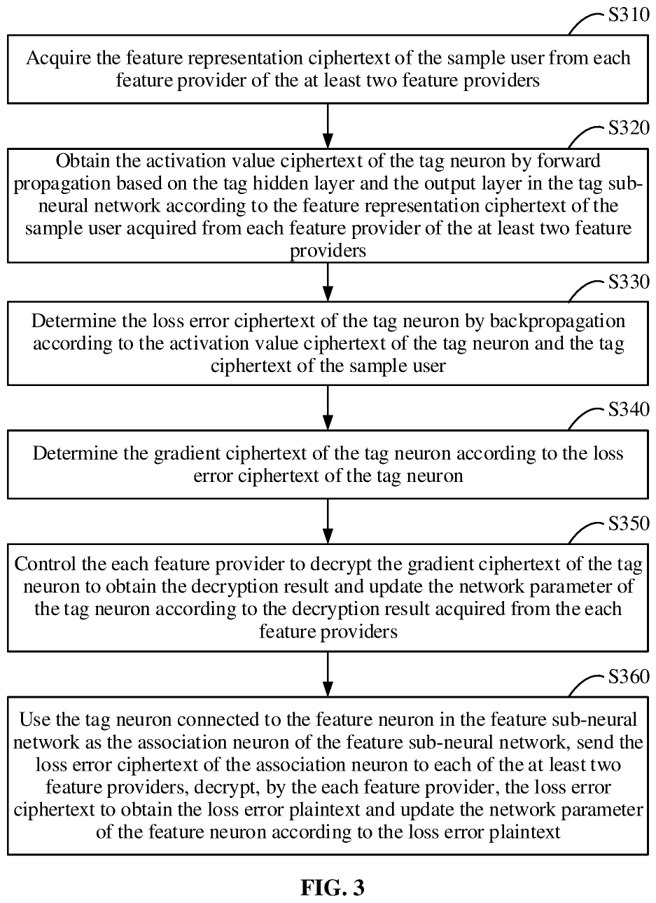

FIG. 3 is a diagram of another training method for a neural network model according to an embodiment of the present disclosure. This embodiment is an optional solution provided based on the preceding embodiments. Referring to FIG. 3, the training method for a neural network model according to this embodiment includes the steps below.

In S310, the feature representation ciphertext of the sample user is acquired from each feature provider of the at least two feature providers separately. The feature representation ciphertext is determined based on the feature sub-neural network in each of the at least two feature providers according to the feature data of the sample user on the feature term associated with the each feature provider.

In S320, based on the tag hidden layer and the output layer in the tag sub-neural network, the activation value ciphertext of the tag neuron is obtained by forward propagation according to the feature representation ciphertext of the sample user acquired from each of the at least two feature providers.

In S330, the loss error ciphertext of the tag neuron is determined by backpropagation according to the activation value ciphertext of the tag neuron and the tag ciphertext of the sample user.

In S340, the gradient ciphertext of the tag neuron is determined according to the loss error ciphertext of the tag neuron.

In S350, each feature provider is controlled to decrypt the gradient ciphertext of the tag neuron to obtain the decryption result, and the network parameter of the tag neuron is updated according to the decryption result acquired from the each feature provider.

In S360, the tag neuron connected to the feature neuron in the feature sub-neural network is used as the association neuron of the feature sub-neural network. The loss error ciphertext of the association neuron is sent to the each feature provider. The loss error ciphertext is decrypted by the each feature provider to obtain the loss error plaintext. The network parameter of the feature neuron is updated according to the loss error plaintext.

The to-be-trained neural network model includes at least two feature sub-neural networks and a tag subnetwork.

In this embodiment of the present disclosure, the tag provider provides only the tag data of the sample user, but does not provide the tag feature data of the sample user. The tag provider may acquire the feature representation ciphertext of the sample user from each feature provider and transmit the feature representation ciphertext of the sample user to the head tag hidden layer in the tag sub-neural network. The activation value ciphertext of the tag neuron in each layer is obtained by forward propagation of each tag hidden layer and each output layer in the tag sub-neural network. The tag provider performs backpropagation through homomorphic ciphertext computation, and the tag provider may also determine the loss function of the output layer according to the tag ciphertext of the sample user and the activation value ciphertext of the output layer and compute the partial derivative of the loss function to the tag neuron to obtain the loss error ciphertext of the tag neuron. The gradient ciphertext of the tag neuron is obtained according to the loss error ciphertext of the tag neuron and the connection weight of the tag neuron.

Specifically, the tag sub-neural network may perform a polynomial approximation to an activation function, for example, the approximation is performed by using Taylor expansion to expand to an n-th power term (such as a quadratic term and a quartic term). In this manner, the loss error ciphertext of the output layer in the tag sub-neural network is expanded to the tag hidden layer. The activation function is used as a sigmoid function to expand to quadratic term f(x)=0.5+×/4. That is, in the case where the activation value ciphertext of an output neuron in the tag sub-neural network is different from the tag ciphertext, the loss function of the output layer may be determined; the loss error of the output layer is expanded to each tag hidden layer to obtain the loss error ciphertext of each tag hidden layer; and the adjustment amount of the weight may be determined according to the gradient adjustment amount of the error. If the accuracy of a set is verified and satisfied an expectation, or the loss error is verified and satisfied an expectation, or the number of training iterations is verified and satisfied an expectation, joint training ends. During model training, forward propagation and backpropagation are performed through homomorphic ciphertext computation, so that not only the tag data can be prevented from being leaked to the feature provider, but also the activation function used by the tag sub-neural network can be prevented from being leaked to the feature provider.

In the technical solution provided by this embodiment of the present disclosure, during the model training, not only the tag data can be prevented from being leaked to the feature provider, but also the activation function used by the tag sub-neural network can be prevented from being leaked to the feature provider, thereby further implementing privacy protection for the tag provider.

In an optional embodiment, controlling the each feature provider to decrypt the gradient ciphertext of the tag neuron to obtain the decryption result and updating the network parameter of the tag neuron according to the decryption result acquired from the each feature provider includes: adding a random mask to the gradient ciphertext of the tag neuron to obtain a gradient masked ciphertext; sending the gradient masked ciphertext to any one feature provider of the at least two feature providers and decrypting, by the any one feature provider, the gradient masked ciphertext to obtain a gradient masked plaintext; and acquiring the gradient masked plaintext from the any one feature provider, removing the random mask from the gradient masked plaintext to obtain a gradient plaintext of the tag neuron and updating the network parameter of the tag neuron by using the gradient plaintext of the tag neuron.

In this embodiment of the present disclosure, the addition method of the random mask is not specifically limited. The tag provider also records the addition method of the random mask to the tag neuron and removes the random mask from the gradient masked plaintext based on the addition method of the random mask to obtain the gradient plaintext of the tag neuron. Compared with directly sending the gradient ciphertext of the tag neuron, the tag provider sends the gradient masked ciphertext to the feature provider, so that the gradient ciphertext of the tag neuron can be prevented from being leaked to the feature provider, and data security of the tag provider can be further improved.

It is to be noted that after the training of the to-be-trained neural network model is completed, the trained neural network model may be used to predict a target user. Specifically, a feature representation ciphertext of the target user is acquired from each feature provider of at least two feature providers separately. Through the feature sub-neural network, the feature representation ciphertext of the target user can be obtained in the following steps. The feature representation plaintext of the target user is determined according to the feature data of the target user on an associated feature term, and the feature representation plaintext of the target user is homomorphically encrypted. Forward propagation is performed based on the tag sub-neural network according to each feature representation ciphertext of the target user to obtain a predicted value ciphertext. A random mask is added to the predicted value ciphertext, and any feature provider may be controlled to perform decryption. The tag provider removes the random mask from the decryption result to obtain a predicted value. During prediction, data security of the target user can be protected.

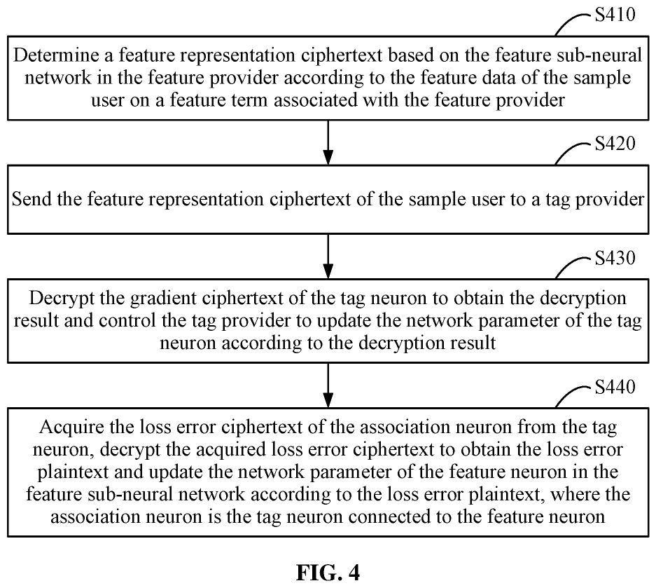

FIG. 4 is a diagram of a training method for a neural network model according to an embodiment of the present disclosure. This embodiment of the present disclosure may be applicable to the case where multiple parties participate in the joint learning. This method may be executed by a training apparatus for a neural network model. This apparatus may be performed by hardware and/or software and may be configured in the electronic device of the feature provider. That is, the training method for a neural network model provided by this embodiment may be executed by the feature provider. Referring to FIG. 4, the method includes the steps below.

In S410, the feature representation ciphertext is determined based on the feature sub-neural network in the feature provider according to the feature data of the sample user on the feature term associated with the feature provider.

In S420, the feature representation ciphertext is sent to the tag provider. The tag provider determines the loss error ciphertext and the gradient ciphertext of the tag neuron in the tag sub-neural network based on the tag sub-neural network according to the feature representation ciphertext acquired from each of the at least two feature providers and the tag ciphertext.

In S430, the gradient ciphertext of the tag neuron is decrypted to obtain the decryption result. The tag provider is controlled to update the network parameter of the tag neuron according to the decryption result.

In S440, the loss error ciphertext of the association neuron is acquired from the tag neuron. The acquired loss error ciphertext is decrypted to obtain the loss error plaintext. The network parameter of the feature neuron in the feature sub-neural network is updated according to the loss error plaintext. The association neuron is the tag neuron connected to the feature neuron.

The to-be-trained neural network model includes at least two feature sub-neural networks and a tag subnetwork.

In this embodiment of the present disclosure, the feature provider is configured to provide the feature data of the sample user on the feature term associated with the feature provider. Each feature provider has a providable feature term associated with the feature provider. The feature term associated with each feature provider is different. The tag provider is configured to provide the tag data of the sample user but not to provide the feature data of the sample user.

Each feature provider has a respective feature sub-neural network. The tag provider has the tag sub-neural network. Each feature sub-neural network and the tag sub-neural network form the to-be-trained neural network model of a distributed structure. The feature sub-neural network may include a feature input layer and a feature hidden layer (which may be referred to as a shallow hidden layer).

Specifically, each feature provider may input the feature data of the sample user on the feature term associated with the feature provider into the respective feature sub-neural network to obtain the output result of the respective feature sub-neural network. The feature representation ciphertext is determined according to the output result. The feature representation ciphertext of the sample user is sent to the tag provider. Moreover, a sample user identifier may be sent to the tag provider. The tag provider may perform ciphertext forward propagation based on each feature representation ciphertext of the sample user to obtain the activation value ciphertext of each tag neuron in the tag sub-neural network. Moreover, homomorphic ciphertext backpropagation is performed. A loss function ciphertext is determined according to the tag ciphertext of the sample user and the activation value ciphertext of the output neuron in the output layer. The loss function ciphertext is expanded to each tag neuron in the tag sub-neural network by the polynomial approximation to obtain the loss error ciphertext of each tag neuron. The gradient ciphertext of the tag neuron is obtained according to the loss error ciphertext of the tag neuron and the connection weight of the tag neuron. The tag provider performs ciphertext forward propagation and ciphertext backpropagation to obtain the loss error ciphertext and the gradient ciphertext of the tag neuron, so that the feature data of the sample user can be prevented from being leaked to the tag provider.

The feature provider may also acquire the gradient ciphertext of the tag neuron from the tag provider and use the homomorphic encryption private key to decrypt the gradient ciphertext of the tag neuron to obtain the decryption result. The decryption result is fed back to the tag provider. The tag provider updates the network parameter of the tag neuron according to the decryption result. The feature provider may also acquire the loss error ciphertext of the respective association neuron, decrypt the loss error ciphertext of the respective association neuron to obtain the loss error plaintext of the respective association neuron and update the network parameter of the feature neuron by using the loss error plaintext of the respective association neuron. The association neuron is the tag neuron connected to the feature neuron. The feature provider acquires the gradient ciphertext of the tag neuron and the loss error plaintext of the respective association neuron from the tag provider, but does not acquire the tag data, so that the tag data can be prevented from being leaked to the feature provider.

In the technical solution provided by this embodiment of the present disclosure, on the premise that each participant does not expose the respective data privacy, there is no need to introduce other trusted parties, and the joint learning is implemented. Moreover, the training computation complexity can also be reduced, and a high applicability is achieved.

In an optional embodiment, determining the feature representation ciphertext based on the feature sub-neural network in the feature provider according to the feature data of the sample user on the feature term associated with the feature provider includes: inputting the feature data of the sample user on the feature term associated with the feature provider into the feature sub-neural network in the feature provider to obtain the feature representation plaintext of the sample user; and performing homomorphic encryption on the feature representation plaintext to obtain the feature representation ciphertext of the sample user. The tag ciphertext is obtained by performing homomorphic encryption on the tag data of the sample user.

Each feature provider may have a homomorphic encryption public key and a homomorphic encryption private key. The homomorphic encryption public key and the homomorphic encryption private key form the asymmetric key pair. The homomorphic encryption public key and the homomorphic encryption private key of each feature provider are the same. The tag provider may also have a homomorphic encryption public key, but not have a homomorphic encryption private key. Joint learning between participants is implemented based on homomorphism encryption, and there is no need to introduce other trusted parties.

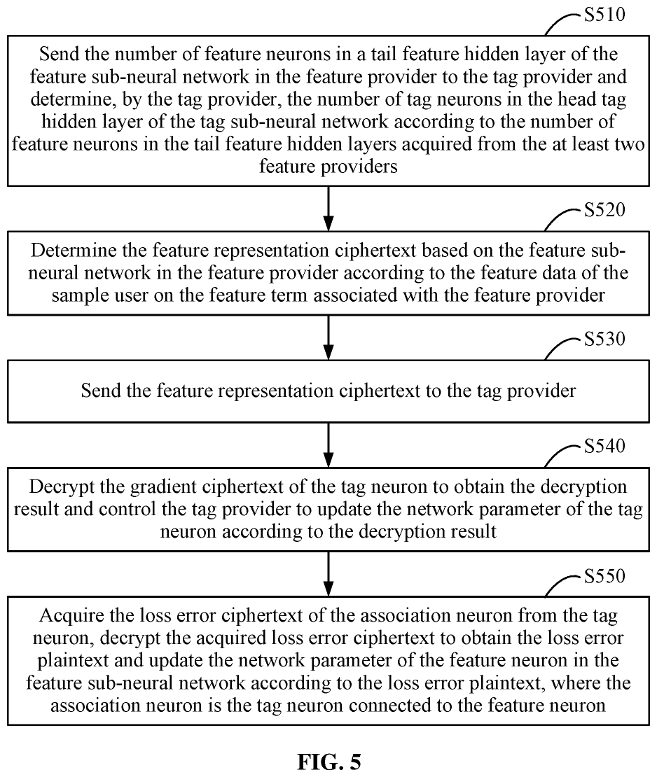

FIG. 5 is a diagram of another training method for a neural network model according to an embodiment of the present disclosure. This embodiment is an optional solution provided based on the preceding embodiments and used to describe the training process of the training model of a candidate neural network model. In this embodiment, the feature sub-neural network includes a feature input layer and at least one feature hidden layer. The tag sub-neural network includes at least one tag hidden layer and an output layer. Referring to FIG. 5, the training method for a neural network model according to this embodiment includes the steps below.

In S510, the number of feature neurons in the tail feature hidden layer of the feature sub-neural network in the feature provider is sent to the tag provider. The tag provider determines the number of tag neurons in the head tag hidden layer of the tag sub-neural network according to the number of feature neurons in the tail feature hidden layers acquired from the at least two feature providers.

In S520, the feature representation ciphertext is determined based on the feature sub-neural network in the feature provider according to the feature data of the sample user on the feature term associated with the feature provider.

In S530, the feature representation ciphertext is sent to the tag provider. The tag provider determines the loss error ciphertext and the gradient ciphertext of the tag neuron in the tag sub-neural network based on the tag sub-neural network according to the feature representation ciphertext acquired from each of the at least two feature providers and the tag ciphertext.

In S540, the gradient ciphertext of the tag neuron is decrypted to obtain the decryption result. The tag provider is controlled to update the network parameter of the tag neuron according to the decryption result.

In S550, the loss error ciphertext of the association neuron is acquired from the tag neuron. The acquired loss error ciphertext is decrypted to obtain the loss error plaintext. The network parameter of the feature neuron in the feature sub-neural network is updated according to the loss error plaintext. The association neuron is the tag neuron connected to the feature neuron.

The to-be-trained neural network model includes at least two feature sub-neural networks and a tag subnetwork.

In this embodiment of the present disclosure, each feature provider may initialize the respective feature sub-neural network separately and send the number of feature neurons in the respective tail feature hidden layer to the tag provider. The tag provider sums the number of tail feature neurons in each feature provider and uses the summation result as the number of tag neurons in the head tag hidden layer in the tag sub-neural network. The adaptability between the tag sub-neural network and each feature sub-neural network can be maintained.

In an optional embodiment, the method also includes sending a candidate user identifier associated with the feature provider to the tag provider and performing the following steps by the tag provider: The intersection of the candidate user identifiers associated with the at least two feature providers is calculated to obtain the common user identifier; and the sample user is determined according to the common user identifier acquired from the tag provider.

In this embodiment, the candidate user identifier associated with the feature provider is the candidate user identifier that the feature provider may provide. Specifically, each feature provider may send the respective associated candidate user identifier to the tag provider. The tag provider calculates the intersection of the candidate user identifiers associated with feature providers to obtain the common user identifier of each feature provider. The tag provider also feeds back the common user identifier to each feature provider. Each feature provider provides the feature representation ciphertext of the sample user according to the common user identifier. That is, the user to which the common user identifier belongs is used as the sample user. The user to which the common user identifier belongs is used as the sample user, then the integrity of the feature data of the sample user is ensured, and the stability of the joint learning is protected.

In the technical solution provided by this embodiment of the present disclosure, the user to which the common user identifier of each feature provider belongs is used as the sample user according to the relationship between the number of first hidden neurons in the tag sub-neural network and the number of tail hidden neurons in each feature sub-neural network, so that the stability of the joint learning can be protected.

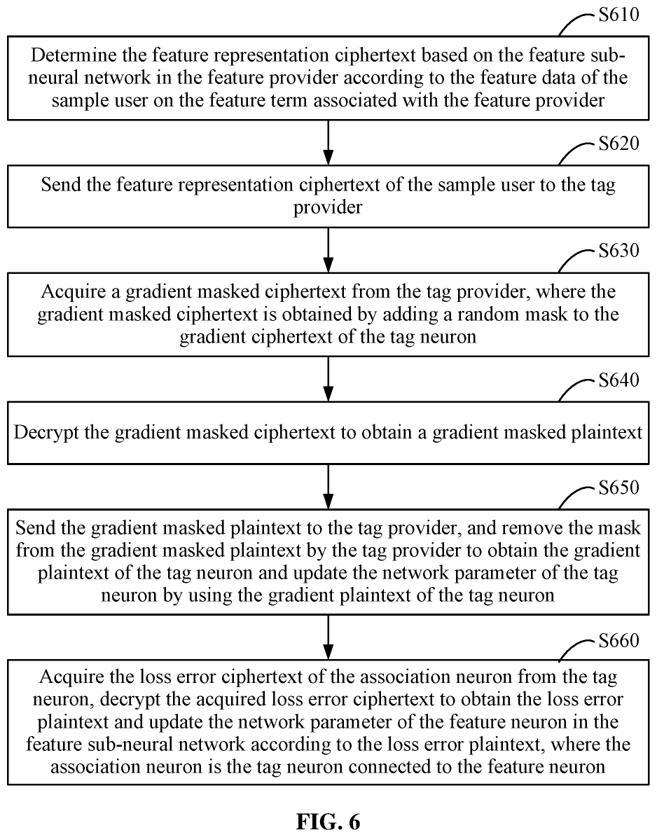

FIG. 6 is a diagram of another training method for a neural network model according to an embodiment of the present disclosure. This embodiment is an optional solution provided based on the preceding embodiments and used to describe the training process of the training model of the candidate neural network model. Referring to FIG. 6, the training method for a neural network model according to this embodiment includes the steps below.

In S610, the feature representation ciphertext is determined based on the feature sub-neural network in the feature provider according to the feature data of the sample user on the feature term associated with the feature provider.

In S620, the feature representation ciphertext is sent to the tag provider. The tag provider determines the loss error ciphertext and the gradient ciphertext of the tag neuron in the tag sub-neural network based on the tag sub-neural network according to the feature representation ciphertext acquired from each of the at least two feature providers and the tag ciphertext.

In S630, the gradient masked ciphertext is acquired from the tag provider. The gradient masked ciphertext is obtained by adding the random mask to the gradient ciphertext of the tag neuron.

In S640, the gradient masked ciphertext is decrypted to obtain the gradient masked plaintext.

In S650, the gradient masked plaintext is sent to the tag provider. The tag provider performs the following steps: The mask is removed from the gradient masked plaintext to obtain the gradient plaintext of the tag neuron; and the gradient plaintext of the tag neuron is used to update the network parameter of the tag neuron.

In S660, the loss error ciphertext of the association neuron is acquired from the tag neuron. The acquired loss error ciphertext is decrypted to obtain the loss error plaintext. The network parameter of the feature neuron in the feature sub-neural network is updated according to the loss error plaintext. The association neuron is the tag neuron connected to the feature neuron.

The to-be-trained neural network model includes at least two feature sub-neural networks and a tag subnetwork.

Specifically, any feature provider may acquire the gradient masked ciphertext of the tag neuron from the tag provider instead of the gradient ciphertext of the tag neuron, so that the gradient ciphertext of the tag neuron can be prevented from being leaked to the feature provider, and the data security of the tag provider can be further improved. The feature provider may be randomly selected by the tag provider from the at least two feature providers.

In the technical solution provided by this embodiment of the present disclosure, the feature provider acquires the gradient masked ciphertext of the tag neuron from the tag provider and decrypts the gradient masked ciphertext to obtain the gradient masked plaintext, so that the gradient ciphertext of the tag neuron can be prevented from being leaked to the feature provider, and the data security of the tag provider can be further improved.

In an optional embodiment, the network parameter of the feature neuron in the feature sub-neural network is updated in the following steps according to the loss error plaintext: The gradient plaintext of the feature neuron in the feature sub-neural network is determined by backpropagation according to the loss error plaintext; and the network parameter of the feature neuron in the feature sub-neural network is updated according to the gradient plaintext of the feature neuron.

Specifically, each feature provider may use the loss error plaintext of the respective association neuron as the loss error plaintext of the tail hidden layer in the respective feature sub-neural network. Backpropagation is performed based on the activation function used by the feature provider. The loss error plaintext of the tail hidden layer is expanded to each feature neuron in the feature sub-neural network by the polynomial approximation to obtain the loss error plaintext of each feature neuron. The gradient plaintext of the feature neuron is obtained according to the loss error plaintext of the feature neuron and the connection weight of the feature neuron. The gradient plaintext of the feature neuron is used to update the network parameter of the feature neuron. The tag provider performs homomorphic ciphertext forward propagation and homomorphic ciphertext backpropagation to obtain the loss error ciphertext and the gradient ciphertext of the tag neuron. Moreover, the feature provider decrypts the loss error ciphertext of the respective association neuron to obtain the loss error plaintext of the association neuron and updates the network parameter of the feature neuron by backpropagation, thereby implementing the update of the feature sub-neural network.

In the technical solution provided by this embodiment of the present disclosure, during model training, not only the tag data of the tag provider and the activation function used by the tag provider can be prevented from leaking to the feature provider, but also the activation function used by the feature provider can be prevented from leaking to the tag provider, thereby further implementing privacy protection for participants.

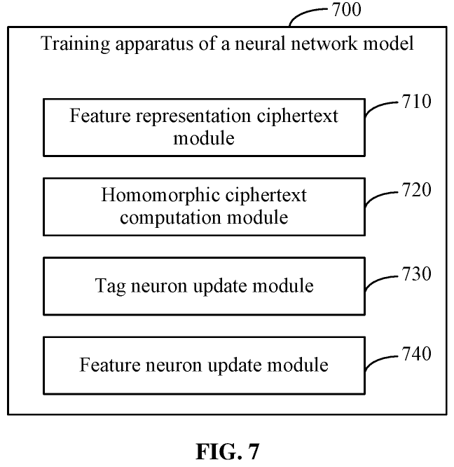

FIG. 7 is a diagram of a training apparatus for a neural network model according to an embodiment of the present disclosure. This embodiment of the present disclosure may be applicable to joint learning. The apparatus is configured in the electronic device of the tag provider and may implement the training method for a neural network model according to any embodiment of the present disclosure. Referring to FIG. 7, the training apparatus 700 of a neural network model includes a feature representation ciphertext module 710, a homomorphic ciphertext computation module 720, a tag neuron update module 730 and a feature neuron update module 740.

The feature representation ciphertext module 710 is configured to acquire the feature representation ciphertext of the sample user from each of the at least two feature providers separately. The feature representation ciphertext is determined based on the feature sub-neural network in each of the at least two feature providers according to the feature data of the sample user on the feature term associated with the feature provider.

The homomorphic ciphertext computation module 720 is configured to determine the tag ciphertext of the sample user and determine the loss error ciphertext and the gradient ciphertext of the tag neuron in the tag sub-neural network based on the tag sub-neural network according to the feature representation ciphertext and the tag ciphertext.

The tag neuron update module 730 is configured to determine the tag ciphertext of the sample user and determine the loss error ciphertext and the gradient ciphertext of the tag neuron in the tag sub-neural network based on the tag sub-neural network according to the feature representation ciphertext and the tag ciphertext.

The feature neuron update module 740 is configured to use the tag neuron connected to the feature neuron in the feature sub-neural network as the association neuron of the feature sub-neural network, send the loss error ciphertext of the association neuron to each feature provider, decrypt, by the each feature provider, the loss error ciphertext to obtain the loss error plaintext and update the network parameter of the feature neuron according to the loss error plaintext.

The to-be-trained neural network model includes at least two feature sub-neural networks and a tag subnetwork.

In an optional embodiment, the feature representation ciphertext is obtained by performing homomorphic encryption on the feature representation plaintext of the sample user. The feature representation plaintext is the output result of the feature sub-neural network with regard to the feature data. The tag ciphertext is obtained by performing homomorphic encryption on the tag data of the sample user.

In an optional embodiment, the feature sub-neural network includes a feature input layer and at least one feature hidden layer. The tag sub-neural network includes at least one tag hidden layer and an output layer.

The training apparatus 700 of a neural network model also includes a neuron number module. The neuron number module includes a feature neuron number unit and a tag neuron number unit.

The feature neuron number unit is configured to acquire the number of feature neurons in the tail feature hidden layer of the feature sub-neural network of each of the at least two feature sub-neural networks from the at least two feature providers separately.

The tag neuron number unit is configured to determine the number of tag neurons in the head tag hidden layer according to the number of feature neurons.

In an optional embodiment, the feature neuron update module 740 is configured to perform the operation below.

The tag neuron connected to the feature neuron in the tail feature hidden layer of the feature sub-neural network is selected from the tag neurons of the head tag hidden layer and used as the association neuron of the sub-feature neural network.

In an optional embodiment, the training apparatus 700 of a neural network model also includes a sample user module. The sample user module includes a candidate user identifier unit, an intersection unit and a common user identifier unit.

The candidate user identifier unit is configured to acquire the candidate user identifier associated with each of the at least two feature providers from each of the at least two feature providers separately.

The intersection unit is configured to calculate the intersection of the candidate user identifiers associated with the at least two feature providers to obtain the common user identifier.

The common user identifier unit is configured to send the common user identifier to the at least two feature providers to determine the sample user based on the common user identifier.

In an optional embodiment, the homomorphic ciphertext computation module includes a forward propagation unit and a backpropagation unit.

The forward propagation unit is configured to obtain the activation value ciphertext of the tag neuron by forward propagation based on the tag hidden layer and the output layer in the tag sub-neural network according to the feature representation ciphertext of the sample user acquired from each of the at least two feature providers.

The backpropagation unit is configured to determine the loss error ciphertext of the tag neuron by backpropagation according to the activation value ciphertext of the tag neuron and the tag ciphertext of the sample user and determine the gradient ciphertext of the tag neuron according to the loss error ciphertext of tag neuron.

In an optional embodiment, the tag neuron update module 730 includes a mask addition unit, a masked ciphertext sending unit and a mask removing unit.

The mask addition unit is configured to add the random mask to the gradient ciphertext of the tag neuron to obtain the gradient masked ciphertext.

The masked ciphertext sending unit is configured to send the gradient masked ciphertext to any feature provider and decrypt the gradient masked ciphertext by the feature provider to obtain the gradient masked plaintext.

The mask removing unit is configured to acquire the gradient masked plaintext from the feature provider, remove the random mask from the gradient masked plaintext to obtain the gradient plaintext of the tag neuron and update the network parameter of the tag neuron by using the gradient plaintext of the tag neuron.

In the technical solution of this embodiment, on the premise that each participant does not expose the respective data privacy, the joint learning is implemented. Moreover, the training computation complexity can also be reduced, and a high applicability is achieved.

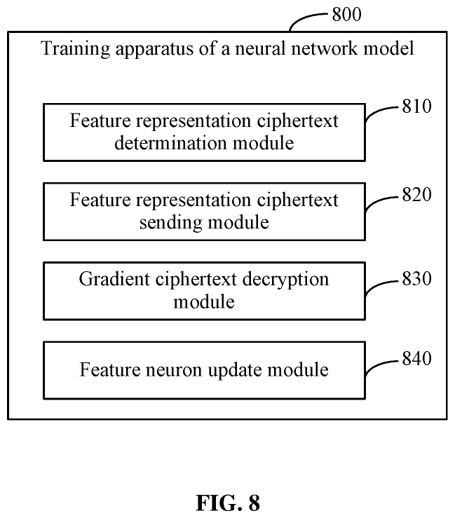

FIG. 8 is a diagram of a training apparatus for a neural network model according to an embodiment of the present disclosure. This embodiment of the present disclosure may be applicable to the joint learning. The apparatus is configured in the electronic device of the feature provider and may implement the training method for a neural network model according to any embodiment of the present disclosure. Referring to FIG. 8, the training apparatus 800 of a neural network model includes a feature representation ciphertext determination module 810, a feature representation ciphertext sending module 820, a gradient ciphertext decryption module 830 and a feature neuron update module 840.

The feature representation ciphertext determination module 810 is configured to determine the feature representation ciphertext based on the feature sub-neural network in the feature provider according to the feature data of the sample user on the feature term associated with the feature provider.

The feature representation ciphertext sending module 820 is configured to send the feature representation ciphertext to the tag provider and configured the tag provider to determine the loss error ciphertext and the gradient ciphertext of the tag neuron in the tag sub-neural network based on the tag sub-neural network according to the feature representation ciphertext acquired from each of the at least two feature providers and the tag ciphertext.

The gradient ciphertext decryption module 830 is configured to decrypt the gradient ciphertext of the tag neuron to obtain the decryption result and control the tag provider to update the network parameter of the tag neuron according to the decryption result.

The feature neuron update module 840 is configured to acquire the loss error ciphertext of the association neuron from the tag neuron, decrypt the acquired loss error ciphertext to obtain the loss error plaintext and update the network parameter of the feature neuron in the feature sub-neural network according to the loss error plaintext. The association neuron is the tag neuron connected to the feature neuron.

The to-be-trained neural network model includes at least two feature sub-neural networks and a tag subnetwork.

In an optional embodiment, the feature representation ciphertext determination module 810 includes a feature representation plaintext unit and a feature representation ciphertext unit.

The feature representation plaintext unit is configured to input the feature data of the sample user on the feature term associated with the feature provider into the feature sub-neural network in the feature provider to obtain the feature representation plaintext of the sample user.

The feature representation ciphertext unit is configured to perform homomorphic encryption on the feature representation plaintext to obtain the feature representation ciphertext of the sample user.

The tag ciphertext is obtained by performing homomorphic encryption on the tag data of the sample user.

In an optional embodiment, the feature sub-neural network includes a feature input layer and at least one feature hidden layer. The tag sub-neural network includes at least one tag hidden layer and an output layer.

The training apparatus 800 of a neural network model also includes a neuron number module. The neuron number module is configured to perform the operations below.

The number of feature neurons in the tail feature hidden layer of the feature sub-neural network in the feature provider is sent to the tag provider. The tag provider determines the number of tag neurons in the head tag hidden layer of the tag sub-neural network according to the number of feature neurons in tail feature hidden layers acquired from the at least two feature providers.

In an optional embodiment, the training apparatus 800 of a neural network model also includes a sample user module. The sample user module includes a candidate user identifier sending unit and a common user identifier unit.

The candidate user identifier sending unit is configured to send the candidate user identifier associated with the feature provider to the tag provider and perform the following step by the tag provider: The intersection of the candidate user identifiers associated with the at least two feature providers is calculated to obtain the common user identifier.

The common user identifier unit is configured to determine the sample user according to the common user identifier acquired from the tag provider.

In an optional embodiment, the gradient ciphertext decryption module 830 includes a masked ciphertext acquisition unit, a masked ciphertext decryption unit and a masked plaintext sending unit.

The masked ciphertext acquisition unit is configured to acquire the gradient masked ciphertext from the tag provider. The gradient masked ciphertext is obtained by adding the random mask to the gradient ciphertext of the tag neuron.

The masked ciphertext decryption unit is configured to decrypt the gradient masked ciphertext to obtain the gradient masked plaintext.

The masked plaintext sending unit is configured to send the gradient masked plaintext to the tag provider and perform the following steps by the tag provider: The mask is removed from the gradient masked plaintext to obtain the gradient plaintext of the tag neuron; and the gradient plaintext of the tag neuron is used to update the network parameter of the tag neuron.

In an optional embodiment, the feature neuron update module 840 includes a backpropagation unit and a feature neuron update unit.

The backpropagation unit is configured to determine the gradient plaintext of the feature neuron in the feature sub-neural network by backpropagation according to the loss error plaintext.

The feature neuron update unit is configured to update the network parameter of the feature neuron in the feature sub-neural network according to the gradient plaintext of the feature neuron.

In the technical solution of this embodiment, on the premise that each participant does not expose the respective data privacy, the joint learning is implemented. Moreover, the training computation complexity can also be reduced, and a high applicability is achieved.

In the technical solutions of the present disclosure, acquisition, storage and application of user personal information involved are in compliance with relevant laws and regulations and do not violate the public order and good customs.

According to an embodiment of the present disclosure, the present disclosure also provides an electronic device, a readable storage medium and a computer program product.

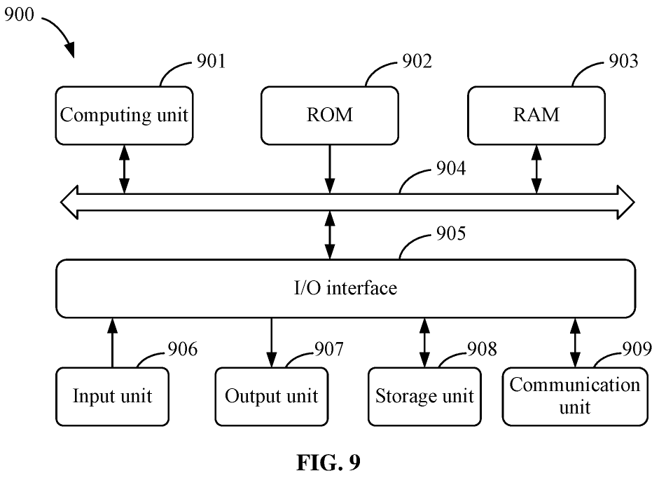

FIG. 9 is a block diagram of an exemplary electronic device 900 that may be configured to perform the embodiments of the present disclosure. The electronic device is intended to represent various forms of digital computers, for example, laptop computers, desktop computers, worktables, personal digital assistants, servers, blade servers, mainframe computers and other applicable computers. The electronic device may also represent various forms of mobile devices, for example, personal digital assistants, cellphones, smartphones, wearable devices and other similar computing devices. Herein the shown components, the connections and relationships between these components and the functions of these components are illustrative merely and are not intended to limit the implementation of the present disclosure as described and/or claimed herein.

As shown in FIG. 9, the device 900 includes a computing unit 901. The computing unit 901 may perform various types of appropriate operations and processing based on a computer program stored in a read-only memory (ROM) 902 or a computer program loaded from a storage unit 908 to a random-access memory (RAM) 903. Various programs and data required for operations of the device 900 may also be stored in the RAM 903. The computing unit 901, the ROM 902 and the RAM 903 are connected to each other by a bus 904. An input/output (I/O) interface 905 is also connected to the bus 904.

Multiple components in the device 900 are connected to the I/O interface 905. The multiple components include an input unit 906 such as a keyboard and a mouse, an output unit 907 such as various types of displays and speakers, the storage unit 908 such as a magnetic disk and an optical disk, and a communication unit 909 such as a network card, a modem or a wireless communication transceiver. The communication unit 909 allows the device 900 to exchange information/data with other devices over a computer network such as the Internet and/or various telecommunications networks.

The computing unit 901 may be various general-purpose and/or special-purpose processing components having processing and computing capabilities. Examples of the computing unit 901 include, but are not limited to, a central processing unit (CPU), a graphics processing unit (GPU), various special-purpose artificial intelligence (Al) computing chips, various computing units executing machine learning model algorithms, a digital signal processor (DSP) and any appropriate processor, controller and microcontroller. The computing unit 901 executes various methods and processing described above, such as a training method for a neural network model. For example, in some embodiments, the training method for a neural network model may be implemented as a computer software program tangibly contained in a machine-readable medium such as the storage unit 908. In some embodiments, part or all of computer programs may be loaded and/or installed on the device 900 via the ROM 902 and/or the communication unit 909. When the computer programs are loaded into the RAM 903 and executed by the computing unit 901, one or more steps of the preceding training method for a neural network model may be performed. Alternatively, in other embodiments, the computing unit 901 may be configured, in any other suitable manner (for example, by means of firmware), to execute the training method for a neural network model.

Herein various embodiments of the systems and techniques described in the preceding may be performed in digital electronic circuitry, integrated circuitry, field-programmable gate arrays (FPGAs), application-specific integrated circuits (ASICs), application-specific standard products (ASSPs), systems on chips (SOCs), complex programmable logic devices (CPLDs), computer hardware, firmware, software and/or combinations thereof. The various embodiments may include implementations in one or more computer programs. The one or more computer programs may be executable and/or interpretable on a programmable system including at least one programmable processor. The programmable processor may be a special-purpose or general-purpose programmable processor for receiving data and instructions from a memory system, at least one input apparatus and at least one output apparatus and transmitting the data and instructions to the memory system, the at least one input apparatus and the at least one output apparatus.

Program codes for implementing the methods of the present disclosure may be compiled in any combination of one or more programming languages. The program codes may be provided for the processor or controller of a general-purpose computer, a special-purpose computer or another programmable data processing apparatus to enable functions/operations specified in flowcharts and/or block diagrams to be implemented when the program codes are executed by the processor or controller. The program codes may be executed in whole on a machine, executed in part on a machine, executed, as a stand-alone software package, in part on a machine and in part on a remote machine, or executed in whole on a remote machine or a server.

In the context of the present disclosure, a machine-readable medium may be a tangible medium that may include or store a program that is used by or in conjunction with an instruction execution system, apparatus or device. The machine-readable medium may be a machine-readable signal medium or a machine-readable storage medium. The machine-readable medium may include, but is not limited to, an electronic, magnetic, optical, electromagnetic, infrared or semiconductor system, apparatus or device, or any suitable combination thereof. Concrete examples of the machine-readable storage medium may include an electrical connection based on one or more wires, a portable computer disk, a hard disk, a random-access memory (RAM), a read-only memory (ROM), an erasable programmable read-only memory (EPROM) or a flash memory, an optical fiber, a portable compact disc read-only memory (CD-ROM), an optical storage device, a magnetic storage device or any appropriate combination thereof.

In order that interaction with a user is provided, the systems and techniques described herein may be implemented on a computer. The computer has a display apparatus (for example, a cathode-ray tube (CRT) or a liquid-crystal display (LCD) monitor) for displaying information to the user and a keyboard and a pointing apparatus (for example, a mouse or a trackball) through which the user can provide input to the computer. Other types of apparatuses may also be used for providing interaction with a user. For example, feedback provided for the user may be sensory feedback in any form (for example, visual feedback, auditory feedback, or haptic feedback). Moreover, input from the user may be received in any form (including acoustic input, voice input, or haptic input).

The systems and techniques described herein may be implemented in a computing system including a back-end component (for example, a data server), a computing system including a middleware component (for example, an application server), a computing system including a front-end component (for example, a client computer having a graphical user interface or a web browser through which a user can interact with implementations of the systems and techniques described herein), or a computing system including any combination of such back-end, middleware or front-end components. Components of a system may be interconnected by any form or medium of digital data communication (for example, a communication network). Examples of the communication network include a local area network (LAN), a wide area network (WAN), a blockchain network and the Internet.

The computing system may include clients and servers. The clients and servers are usually far away from each other and generally interact through the communication network. The relationship between the client and the server arises by virtue of computer programs running on respective computers and having a client-server relationship to each other. The server may be a cloud server, also referred to as a cloud computing server or a cloud host. As a host product in a cloud computing service system, the server solves the defects of difficult management and weak service scalability in a related physical host and a related VPS service.

It is to be understood that various forms of the preceding flows may be used with steps reordered, added, or removed. For example, the steps described in the present disclosure may be executed in parallel, in sequence or in a different order as long as the desired result of the technical solutions disclosed in the present disclosure is achieved. The execution sequence of these steps is not limited herein.

The scope of the present disclosure is not limited to the preceding embodiments. It is to be understood by those skilled in the art that various modifications, combinations, subcombinations and substitutions may be made according to design requirements and other factors. Any modification, equivalent substitution, improvement and the like made within the spirit and principle of the present disclosure falls within the scope of the present disclosure.

What is claimed is:

1. A training method for a neural network model, comprising:
acquiring a feature representation ciphertext of a sample user from each feature provider of at least two feature providers separately, wherein the feature representation ciphertext is determined based on a feature sub-neural network in the each feature provider according to feature data of the sample user on a feature term associated with the each feature provider;
determining a tag ciphertext of the sample user and determining a loss error ciphertext and a gradient ciphertext of a tag neuron in a tag sub-neural network based on the tag sub-neural network according to the feature representation ciphertext and the tag ciphertext;
controlling the each feature provider to decrypt the gradient ciphertext of the tag neuron to obtain a decryption result and updating a network parameter of the tag neuron according to the decryption result acquired from the each feature provider; and
using a tag neuron connected to a feature neuron in the feature sub-neural network as an association neuron of the feature sub-neural network, sending a loss error ciphertext of the association neuron to the each feature provider, decrypting, by the each feature provider, the loss error ciphertext to obtain a loss error plaintext and updating a network parameter of the feature neuron according to the loss error plaintext,
wherein the to-be-trained neural network model comprises at least two feature sub-neural networks and the tag sub-neural network.

2. The method according to claim 1, wherein the feature representation ciphertext is obtained by performing homomorphic encryption on a feature representation plaintext of the sample user, the feature representation plaintext is an output result of the feature sub-neural network with regard to the feature data, and the tag ciphertext is obtained by performing homomorphic encryption on tag data of the sample user.

3. The method according to claim 1, wherein the feature sub-neural network comprises a feature input layer and at least one feature hidden layer, and the tag sub-neural network comprises at least one tag hidden layer and an output layer; and
wherein the method further comprises:
acquiring a number of feature neurons in a tail feature hidden layer of the at least one feature hidden layer of the feature sub-neural network from the each feature provider separately; and
determining a number of tag neurons in a head tag hidden layer of the at least one tag hidden layer according to the number of feature neurons.

4. The method according to claim 3, wherein the using the tag neuron connected to the feature neuron in the feature sub-neural network as the association neuron of the feature sub-neural network comprises:
selecting, from the tag neurons in the head tag hidden layer, a tag neuron connected to a feature neuron of the feature neurons in the tail feature hidden layer of the feature sub-neural network and using the selected tag neuron as the association neuron of the feature sub-neural network.

5. The method according to claim 1, further comprising:
acquiring a candidate user identifier associated with the each feature provider from the at least two feature providers separately;
calculating an intersection of candidate user identifiers associated with the at least two feature providers to obtain a common user identifier; and
sending the common user identifier to the at least two feature providers to determine the sample user based on the common user identifier.

6. The method according to claim 1, wherein the determining the loss error ciphertext and the gradient ciphertext of the tag neuron in the tag sub-neural network based on the tag sub-neural network according to the feature representation ciphertext and the tag ciphertext comprises:
obtaining an activation value ciphertext of the tag neuron by forward propagation based on a tag hidden layer and an output layer in the tag sub-neural network according to the feature representation ciphertext of the sample user acquired from the at least two feature providers;
determining the loss error ciphertext of the tag neuron by backpropagation according to the activation value ciphertext of the tag neuron and the tag ciphertext of the sample user; and
determining the gradient ciphertext of the tag neuron according to the loss error ciphertext of the tag neuron.

7. The method according to claim 1, wherein controlling the each feature provider to decrypt the gradient ciphertext of the tag neuron to obtain the decryption result and updating the network parameter of the tag neuron according to the decryption result acquired from the each feature provider comprise:
adding a random mask to the gradient ciphertext of the tag neuron to obtain a gradient masked ciphertext;
sending the gradient masked ciphertext to any one feature provider of the at least two feature providers and decrypting, by the any one feature provider, the gradient masked ciphertext to obtain a gradient masked plaintext; and
acquiring the gradient masked plaintext from the any one feature provider, removing the random mask from the gradient masked plaintext to obtain a gradient plaintext of the tag neuron and updating the network parameter of the tag neuron by using the gradient plaintext of the tag neuron.

8. A training method for a neural network model, comprising:
determining a feature representation ciphertext based on a feature sub-neural network in a feature provider according to feature data of a sample user on a feature term associated with the feature provider;
sending the feature representation ciphertext to a tag provider and determining, by the tag provider, a loss error ciphertext and a gradient ciphertext of a tag neuron in a tag sub-neural network based on the tag sub-neural network according to a feature representation ciphertext acquired from each of at least two feature providers and a tag ciphertext;
decrypting the gradient ciphertext of the tag neuron to obtain a decryption result and controlling the tag provider to update a network parameter of the tag neuron according to the decryption result; and
acquiring a loss error ciphertext of an association neuron from the tag neuron, decrypting the acquired loss error ciphertext to obtain a loss error plaintext and updating a network parameter of a feature neuron in the feature sub-neural network according to the loss error plaintext, wherein the association neuron is a tag neuron connected to the feature neuron,
wherein the to-be-trained neural network model comprises at least two feature sub-neural networks and the tag subnetwork.

9. The method according to claim 8, wherein the determining the feature representation ciphertext based on the feature sub-neural network in the feature provider according to the feature data of the sample user on the feature term associated with the feature provider comprises:
inputting the feature data of the sample user on the feature term associated with the feature provider into the feature sub-neural network in the feature provider to obtain a feature representation plaintext of the sample user; and
performing homomorphic encryption on the feature representation plaintext to obtain the feature representation ciphertext of the sample user,
wherein the tag ciphertext is obtained by performing homomorphic encryption on tag data of the sample user.

10. The method according to claim 8, wherein the feature sub-neural network comprises a feature input layer and at least one feature hidden layer, and the tag sub-neural network comprises at least one tag hidden layer and an output layer; and
wherein the method further comprises:
sending, to the tag provider, a number of feature neurons in a tail feature hidden layer of the at least one feature hidden layer of the feature sub-neural network in the feature provider and determining, by the tag provider, a number of tag neurons in a head tag hidden layer of the at least one tag hidden layer of the tag sub-neural network according to a number of feature neurons in tail feature hidden layers of the at least one feature hidden layer acquired from the at least two feature providers.

11. The method according to claim 8, further comprising:
sending a candidate user identifier associated with the feature provider to the tag provider and performing the following by the tag provider: calculating an intersection of candidate user identifiers associated with the at least two feature providers to obtain a common user identifier; and
determining the sample user according to the common user identifier acquired from the tag provider.

12. The method according to claim 8, wherein the decrypting the gradient ciphertext of the tag neuron to obtain the decryption result and controlling the tag provider to update the network parameter of the tag neuron according to the decryption result comprise:
acquiring a gradient masked ciphertext from the tag provider, wherein the gradient masked ciphertext is obtained by adding a random mask to the gradient ciphertext of the tag neuron;
decrypting the gradient masked ciphertext to obtain a gradient masked plaintext; and
sending the gradient masked plaintext to the tag provider and performing the following by the tag provider: removing the mask from the gradient masked plaintext to obtain a gradient plaintext of the tag neuron and using the gradient plaintext of the tag neuron to update the network parameter of the tag neuron.

13. The method according to claim 8, wherein the updating the network parameter of the feature neuron in the feature sub-neural network according to the loss error plaintext comprises:
determining a gradient plaintext of the feature neuron in the feature sub-neural network by backpropagation according to the loss error plaintext; and
updating the network parameter of the feature neuron in the feature sub-neural network according to the gradient plaintext of the feature neuron.

14. An electronic device, comprising:
at least one processor; and
a memory communicatively connected to the at least one processor,
wherein the memory stores instructions executable by the at least one processor to enable the at least one processor to execute a training method for a neural network model, and the training method comprises:
acquiring a feature representation ciphertext of a sample user from each feature provider of at least two feature providers separately, wherein the feature representation ciphertext is determined based on a feature sub-neural network in the each feature provider according to feature data of the sample user on a feature term associated with the each feature provider;
determining a tag ciphertext of the sample user and determining a loss error ciphertext and a gradient ciphertext of a tag neuron in a tag sub-neural network based on the tag sub-neural network according to the feature representation ciphertext and the tag ciphertext;
controlling the each feature provider to decrypt the gradient ciphertext of the tag neuron to obtain a decryption result and updating a network parameter of the tag neuron according to the decryption result acquired from the each feature provider; and
using a tag neuron connected to a feature neuron in the feature sub-neural network as an association neuron of the feature sub-neural network, sending a loss error ciphertext of the association neuron to the each feature provider, decrypting, by the each feature provider, the loss error ciphertext to obtain a loss error plaintext and updating a network parameter of the feature neuron according to the loss error plaintext,
wherein the to-be-trained neural network model comprises at least two feature sub-neural networks and the tag sub-neural network.

15. The electronic device according to claim 14, wherein the feature representation ciphertext is obtained by performing homomorphic encryption on a feature representation plaintext of the sample user, the feature representation plaintext is an output result of the feature sub-neural network with regard to the feature data, and the tag ciphertext is obtained by performing homomorphic encryption on tag data of the sample user.

16. The electronic device according to claim 14, wherein the feature sub-neural network comprises a feature input layer and at least one feature hidden layer, and the tag sub-neural network comprises at least one tag hidden layer and an output layer; and
wherein the method further comprises:
acquiring a number of feature neurons in a tail feature hidden layer of the at least one feature hidden layer of the feature sub-neural network from the each feature provider separately; and
determining a number of tag neurons in a head tag hidden layer of the at least one tag hidden layer according to the number of feature neurons.

17. The electronic device according to claim 16, wherein the using the tag neuron connected to the feature neuron in the feature sub-neural network as the association neuron of the feature sub-neural network comprises:
selecting, from the tag neurons in the head tag hidden layer, a tag neuron connected to a feature neuron of the feature neurons in the tail feature hidden layer of the feature sub-neural network and using the selected tag neuron as the association neuron of the feature sub-neural network.

18. The electronic device according to claim 14, further comprising:
acquiring a candidate user identifier associated with the each feature provider from the at least two feature providers separately;
calculating an intersection of candidate user identifiers associated with the at least two feature providers to obtain a common user identifier; and
sending the common user identifier to the at least two feature providers to determine the sample user based on the common user identifier.

19. The electronic device according to claim 14, wherein the determining the loss error ciphertext and the gradient ciphertext of the tag neuron in the tag sub-neural network based on the tag sub-neural network according to the feature representation ciphertext and the tag ciphertext comprises:
obtaining an activation value ciphertext of the tag neuron by forward propagation based on a tag hidden layer and an output layer in the tag sub-neural network according to the feature representation ciphertext of the sample user acquired from the at least two feature providers;
determining the loss error ciphertext of the tag neuron by backpropagation according to the activation value ciphertext of the tag neuron and the tag ciphertext of the sample user; and
determining the gradient ciphertext of the tag neuron according to the loss error ciphertext of the tag neuron.

20. A non-transitory computer-readable storage medium storing computer instructions for causing a computer to execute the method according to claim 1.
